(19) United States
(12) Patent Application Publication
(10) Pub. No.: US 2007/0131325 A1
(43) Pub. Date: Jun. 14, 2007

(54) Slip-preventing device for vehicle tire

(76) Inventor: Kouichi Sakakibara, Gifu-ken (JP)

Correspondence Address: Kouichi Sakakibara, 1-103-1 Sugaminami Hotsu-cho, Hashima-shi Gifu-ken, 501-6335, JP

(21) Appl. No.: 10/588,468

(22) PCT Filed: Apr. 27, 2005
(86) PCT No.: PCT/JP05/08545

§ 371 Date: Aug. 3, 2006

(30) Foreign Application Priority Data
May 24, 2004 (JP) 2004-194751
Oct. 21, 2004 (JP) 2004-349129

(51) Int. Cl. B60C 27/00

(52) U.S. Cl. 152/216

(57) ABSTRACT

A slip-preventing device has plural sets of arm frames for a tire. Each set of the arm frames has a pair of crossing components, an inner side component and a pair of outer side components. Each pair of the crossing components is bent closely on the tread of the tire so as to extend to part of an inner sidewall and to part of an outer sidewall. The inner side component connects bent parts of the pair of-crossing components with each other along part of the curved surface of the inner sidewall: Each pair of the outer side components extends in the circumferential direction of the tire along part of the curved surface of the outer sidewall from bent parts of the pair of the crossing components. Each of the arm frames has: a link unit at each leading end of the outer side components so as to link detachably with the other arm frame fitted next in the installation on the tire. The arm frames are linked with each other only by the link unit.

### BACKGROUND OF THE INVENTION

1. Field of the Invention

This invention relates to a slip-preventing device for a tire that is attached to the tire of an automobile or the like so as to prevent the tires from slippage on a snow-covered road or a frozen road in winter.

2. Descripthion of the Related Art

Conventionally, a variety of tires such as snow tires, studded tires, studless snow tires and tire chains into a net shape or the like are supplied to improve slip-preventing on a snow-covered road and so on. The fitting work, sometimes with a jack, moving wheels back and forth, linking on an inner sidewall of a tire and striking a balance for linking on an outer sidewall of the tire is very complicated and troublesome, particularly, for women or even men at night or on the spot.

This invention is for improvements over the former invention (patent application No. 2001-402096=patent publication No.2003-89307) by the same inventor and applicant. The improvements are in easy manufacturing and safe fitting.

[Patent Reference 1] Patent Publication No. 2003-89307, Official Report.

### BRIEF SUMMARY OF THE INVENTION

Generally, it is very laborious and takes much time to fit conventional tire chains on tires. For example, after arranging the most prevalent ladder-shaped tire chains without twists in front of tires, the car is moved forward a little to put the treads of the tires on the chains. Then, the chains are wound around outer circumferences of the treads and the both ends are linked with linking portions. The crossing components (along the broad direction of the treads) must strike a balance on the tires. Then, the chains are arranged without slack and bias, and attached chain bands (the linking portions of the crossing components along the circumferential direction of the sidewalls) are caught on the tire chains to strike a balance of the whole tire chains. These works are so complicated and troublesome that general users who handle tire chains once or twice a year need much time. Particularly, the fitting work becomes more difficult under bad condition such as on a snow-covered road. Moreover, the attaching work is very hard for users who are weak such as women or the like.

It is an object of the invention to provide a slip-preventing device for a tire that enables anyone to fit on the tire in a short time.

According to a first aspect of the invention, there is provided a slip-preventing device comprising plural sets of arm frames for a tire. Each set of the arm frames has a pair of crossing components, an inner side component and a pair of outer side components. Each pair of the crossing components is bent closely on the tread of the tire so as to extend to part of an inner sidewall and to part of an outer sidewall. The inner side component connects bent parts of the pair of crossing components with each other along part of the curved surface of the inner sidewall. Each pair of the outer side components extends in the circumferential direction of the tire along part of the curved surface of the outer sidewall from bent parts of the pair of the crossing components. Each of the arm frames has a link unit at each leading end of the outer side components so as to link detachably with the other arm frame fitted next in the installation on the tire. The arm frames are linked with each other only by the link unit. With such features, the slip-preventing device can be made into the simplest structure. The slip-preventing device can be held on the tire by itself by connecting the arm frames. That is, the slip-preventing device is continuous at the inner sidewall, the tread and the outer sidewall of the tire, so that it never physically comes off the tire. At the time of gripping by rotating the tire, a weight of a vehicle is applied to a portion of the arm frame that touches a ground surface of a road. Particularly, a width of the tire enlarges to inside and outside directions, thereby increasing a force to hold the arm frame on the tire. A set of the arm frames are linked at the inner sidewall, the tread and the outer sidewall so as to round the tire. Consequently, the set of the arm frames as a whole absorbs vibration. Moreover, the arm frames become in a centripetal state so that there arises friction at the portion of the arm frame that touches the ground surface, thereby acting as the slip-preventing device. With such features, the slip-preventing device can be manufactured more easily and fitted more safely.

According to a second aspect of the invention, there is provided a slip-preventing device of the tire in which each of the arm frames further has a reinforcing portion which connects bent parts of a pair of crossing components on the outer side of the tire. Thus, the reinforcement on the outer sidewall increases the strength of the arm frames as a whole.

According to a third aspect of the invention, there is provided a slip-preventing device of the tire in which each of the arm frames further has a free joint unit at the middle position on the inner side of the tire. Thus, the free join unit releases a torque applied to the arm frame following deformation of the tire (by the weight of the chassis, etc.) and vibration or the like.

According to a fourth aspect of the invention, there is provided a slip-preventing device of the tire in which each of the arm frames has an elastic body fitted on the free joint unit. (in this case, the elastic body is composed of a spring, rubber or the like.)

According to a fifth aspect of the invention, there is provided a slip-preventing device comprising two, three or four sets of arm frames for a tire.

According to a sixth aspect of the invention, there is provided a slip-preventing device comprising three sets of arm frames for a tire.

The above-mentioned slip-preventing device is so simple, durable and frictional that anybody can install or remove them easily anywhere and anytime. Consequently, this invention may be helpful enough to reduce traffic accidents in winter because the higher percent of drivers install these useful devices even for an emergency.

### BRIEF DESCRIPTION OF THE DRAWINGS

FIG. 1 is a partially explanatory drawing showing an outer side of a slip-preventing device comprising 3 sets of arm frames. (for one tire) that is installed on the tire.

FIG. 2 is a partially explanatory drawing showing a front side of FIG. 1.

FIG. 3 is a partially plan view of a free joint unit.

FIG. 4 is a partially plan view of a link unit.

### ILLUSTRATIONS

1. tire
2. wheel
3. arm frame (outer side component)
4. link unit
5. free joint unit
6. ground-touching surface
7. turning direction (tire)
8. arm frame (inner side component)
9. inner periphery of tire
10. diameter of wheel
11. outside surface of tire
12. inside surface of tire
13. spring
14. metal hook (hooking dent)
15. rivet
16. arm frame (tread)
17. next arm frame (hooking protrusion)

### DESCRIPTION OF THE PREFERRED EMBODIMENTS

The slip-preventing device is preferable to install on an inflated driving wheel of a car with four wheel drive at a top speed of 50 km per hour without scrambles and sharp turn.

Several embodiments of the invention are described hereunder referring to the attached drawings.

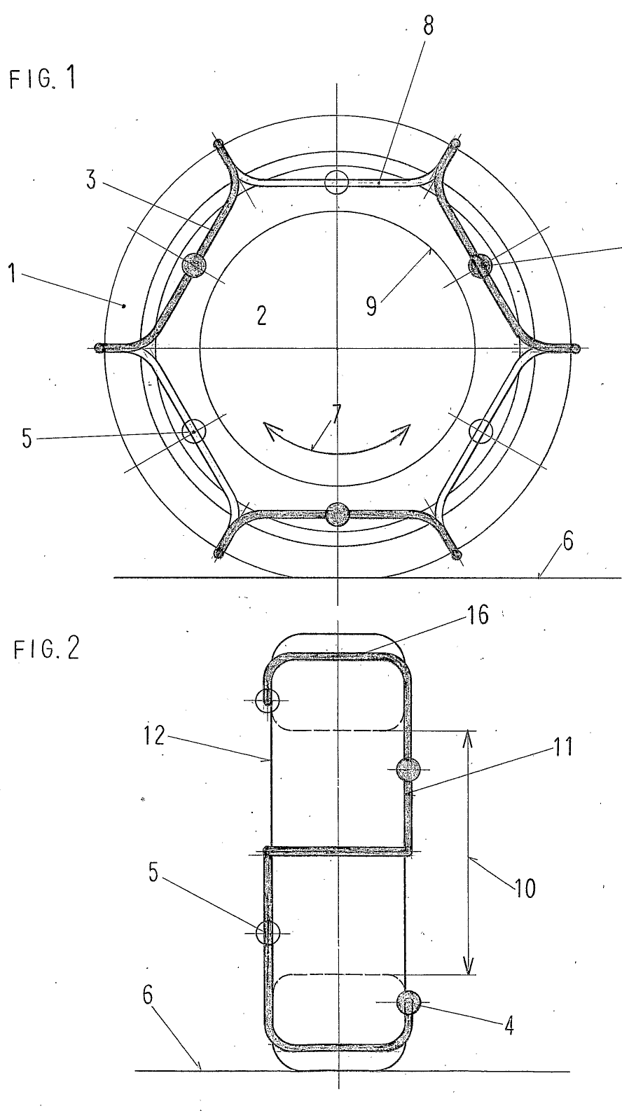

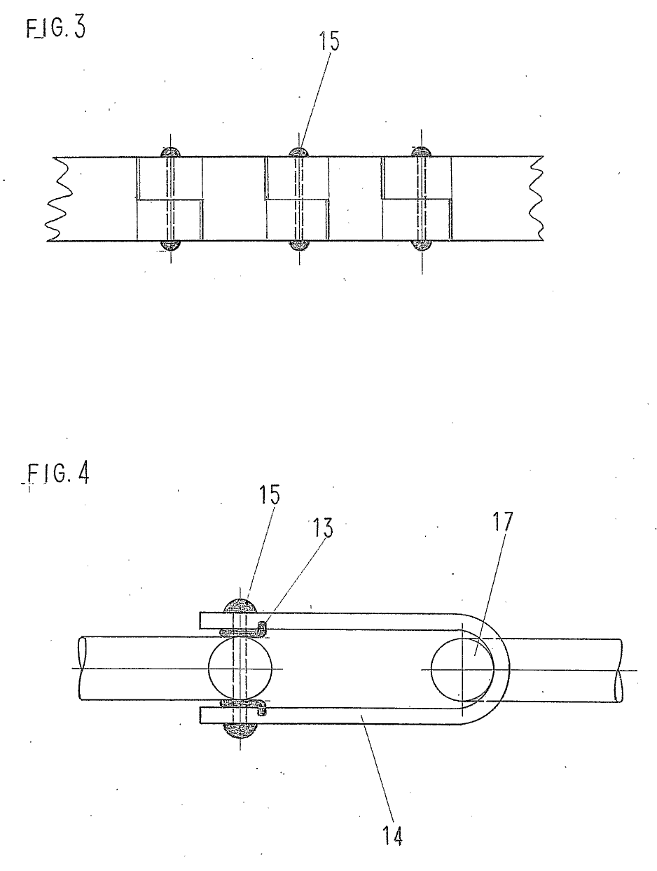

FIG. 1. is an outer side view of a slip preventing device comprising 3 sets of arm frames for one tire in bold solid lines and an inner side view (of a sidewall) of a tire in fine double lines. In order to install the slip-preventing device on the tire, first, a pair of arm frames is moved toward the tire from the upper part and fitted across the tire. At this time, the inside portion is caught on the inner sidewall. Then, the set of arm frames is moved to one side, e.g. the left side. Three sets of arm frames are arranged over an angle of about 120 degrees in the circumferential direction of the tire, respectively, thereby extending 360 degrees in total. The portions of the arm frames that touch a ground surface of a road are disposed at an angular interval of 60 degrees. The treads of two sets arranged over an angle of 180 degrees are disposed at an angular interval of 90 degrees, while the treads of four sets arranged over an angle of 90 degrees are disposed at an angular interval of 45 degrees, basically. The slip-preventing device comprising even four sets of arm frames can be easily installed on the tire without moving the wheels back and forth, because tires touch a ground surface usually at an angular interval of about 35 to 40 degrees depending on the conditions of air pressures and weights of cars. After the first set of arm frames is fitted across the upper part of the tire and moved lower on one side, e.g. the left side as described above, the second set of arm frames is also fitted across the upper part of the tire and moved toward the other side, e.g. the right side. Then, the linking portions located substantially at a center on a tread are linked with each other. The third set of arm frames is fitted also across the upper part of the tire and linked by link units. Thus, the slip-preventing device can be easily attached. When it is removed, the procedure is reversed. Two sets of arm frames with only four arm frames on the tread are the simplest and seem to be enough in usual cases, while four sets of arm frames with eight arm frames on the tread are frictional. The link unit may be composed of a sliding lock, a bolt or a pin lock. FIG. 4 is a partially plan view of hooking portions with springs, which may link the two members to be linked so as to make them relatively movable in stead of a free joint unit, because a force applied to the arm frame and vibration or the like are released there. FIG. 2 is a partially explanatory drawing showing a front side of the slip-preventing device comprising 3 sets of arm frames that is installed on the tire. FIG. 3 is a partially plan view of a free joint unit provided on the arm frames which releases a force applied to each arm frame when the tire receives vibration or torque on the tread. A cushioned tire for a passenger car absorbs about 3 to 5 percent of eccentricity at the time of running. The free joint unit may be constructed by combining ones that are capable of bending in a reverse direction at 90 degrees. In this case, the free joint unit defines a connecting portion and functions to move in the arm frame. For the free joint unit, any kind of chains, flexible wires or rubber, especially strong rubber may be provided, while a spring (a coil spring) may be mounted for linking and rotating partially. Using them in combination is usual. For the arm frames, any kind such as stainless (304 or 310), steel alloy, FRP or carbon is used; besides, the composite material or coated material. The rod shape made of one or more rods is preferable. (The bigger diameter than the outside diameter of a tire becomes close to the minimum diameter by welding. Production cost for a board shape becomes lower by mass production.) A reinforcing rod may be arranged between bent parts of each pair of crossing components on the outside wall of the tire where linking is easy. The reinforcing rod which reinforces the arm frame as strongly as possible may provide the elastic body on the free joint unit.

As described above, 2, 3 or 4 sets of arm frames for one tire are usual because the tire touches the ground surface usually at an angular interval of about 35 to 40 degrees, that is, the treads of 5 sets must be disposed at an angular interval of about 35 to 30 degrees, which is unbalanced on the tread, uneconomical and inefficient. The three sets of arm frames for one tire seem to be the best synthetically.

Other Modifications

As described above, preferable as the material of the arm frame is the one that has property such as necessary elasticity (flexibility), strength or the like and that is hard to be abraded. The elastic body fitted on the free joint unit has a function to move smoothly (with a little resistance). The arm frame with the (little smaller) outside diameter close to the inner center a little by the elastic body on the free joint unit is pressed a little tight on the tire. Granting the tire somewhat wears out, the arm frames can always become in a centripetal state by themselves so that the outside diameter may become less. As shown in FIG. 1 and FIG. 2, the arm frames are extended from the tread toward the center of the wheel (to the curved surface and the sidewall) as much as possible, thereby making the device expensive, (at least, perpendicularly up to the end of the curved surface.) so that the arm frames never come off the tire even when the tire becomes in a centrifugal state at the time of turning, and the tread of arm frames and the surface contacting with the tire enlarge because of the shape of the tire, the air pressure, the speed and the curve, etc.

Consequently, this ideal slip-preventing device attached and removed easily especially on the frozen road in winter will come into wide use with rapidity in the car-oriented society (only with Patent Reference 1 Patent Publication 2003-89307, Official Report)

The preferred embodiments described herein are illustrative and not restrictive, the scope of the invention being indicated in the appended claims and all variations that come within the meaning of the claims are intended to be embraced therein.

1. A slip-preventing device comprising plural sets of arm frames for a tire, each set of the arm frames including a pair of crossing components, an inner side component and a pair of outer side components, each pair of the crossing components being bent closely on the tread of the tire so as to extend to part of an inner sidewall and to part of an outer sidewall, the inner side component connecting bent parts of the pair of crossing components with each other along part of the curved surface of the inner sidewall, each pair of the outer side components extending in the circumferential direction along part of the curved surface of the outer sidewall from bent parts of the pair of the crossing components, each of the arm frames having a link unit at each leading end of the outer side components so as to link detachably with the other arm frame fitted next in the installation on the tire, and the arm frames being linked with each other only by the link unit in the installation on the tire.

2. A slip-preventing device according to claim 1, in which each of the arm frames further has a reinforcing portion which connects bent parts of a pair of the crossing components on the outer side of the tire.

3. A slip-preventing device according to claim 2, in which each of the arm frames further has a free joint unit at the middle position on the inner side of the tire.

4. A slip-preventing device according to claim 3, in which each of the arm frames further has an elastic body fitted on the free joint unit.

5. A slip-preventing device according to claim 1, 2, 3 or 4, comprising two, three or four sets of arm frames for one tire.

6. A slip-preventing device according to claim 5, comprising three sets of arm frames for one tire.

7. A slip-preventing device according to claim 1, 2, 3, 4, 5 or 6, comprising plural arm frames linked with each other so as to fix movably, and one arm frame being linked detachably with the other arm frame fitted next only with a link unit on the outer side of a tire.
